(19) United States
(12) Patent Application Publication
(10) Pub. No.: US 2012/0048203 A1
(43) Pub. Date: Mar. 1, 2012

(54) Method and apparatus for encouraging citizens to acquire biological data by adding sensors to a camera-equipped birdhouse

(76) Inventor: Douglas M. Bonham, Essex, MT (US)

(21) Appl. No.: 12/873,525

(22) Filed: Sep. 1, 2010

(51) Int. Cl. A01K 1/03; A01K 31/00

(52) U.S. Cl. 119/421

(57) ABSTRACT

A method and apparatus for encouraging a citizen-based effort to collect and compile scientifically-valid biological information utilizing the popular appeal of camera-equipped birdhouses integrated with an electronic apparatus that collects biological and environmental data in a controlled and repeatable fashion suitable for contribution to a centralized database. The apparatus is used to monitor a wildlife nest, den or roost. The apparatus comprises a birdhouse with an electronic circuit for controlling an image sensor, motion detector, light detector and means of communicating with an Internet-connected computer or handheld device.

### FIELD OF THE INVENTION

The present invention relates to methods and apparatus for fostering a broad citizen scientist effort to acquire long-term and scientifically valid biological data on the behavior and timing of cavity-nesting birds and other wildlife by taking advantage of the popular appeal of cameras in backyard birdhouses and adding precise scientific instruments that acquire data on feeding rates and other behaviors that can be uploaded to centralized databases.

### BACKGROUND OF THE INVENTION

The National Phenology Network is a new federal multi-agency effort to monitor climate change by fostering a broad citizen scientist effort to record and report the timing of natural events such as flowers blooming, birds migrating, insects hatching and other animal behaviors and environmental phenomenon (USANPN 2010). The potential to inexpensively gather vast amounts of long-term environmental data by enlisting contributions from untrained but motivated citizens is attractive, however the challenge with such citizen-based programs has always been the questionable reliability and repeatability of the methods and data for making valid scientific conclusions. The annual Christmas Bird Count is conducted and managed by up to 50,000 volunteer amateur birdwatchers with the National Audubon Society and has been gathering data for 110 years. Although data from these counts does appear in scientific journals it is always qualified and of limited value due to poorly-controlled methods and wide variations in the levels of training and expertise of the participants.

Gathering valid scientific field data on environmental phenomenon can be tedious and requires substantial attention to detail and documentation of methods and results. It is often carried out with the assistance of expensive software-controlled scientific instruments that take care of much of the tedium and precise repeatability. The price of such instruments is normally beyond ordinary consumers but the price could be substantially reduced if they were mass-produced in numbers more in line with consumer products. If such devices were deployed in large numbers across wide geographic regions the voluminous data would be extremely valuable for wildlife, environmental and climate sciences.

Many, if not most homeowners have purchased and installed backyard birdhouses or birdfeeders, and recently the advent of small commercial digital cameras on or inside of birdhouses has added to the recreational potential for such devices (Hawk Eye 2010, Cornell 2010). Birdhouses also provide an excellent opportunity to gather valid biological data using motion sensors, thermometers, infrared detectors, light sensors, gram-scales, and software analyzed sounds and images. For instance, a data-logger and motion detector installed at the entrance of a birdhouse can compile and store an archive of feeding rates. The ability of adult birds to find food for their young is a valuable indicator of the surrounding habitat quality and species health. In addition to feeding rates, motion detectors can provide data on nest selection, nest building, fledging, roosting, predation and nest parasitism.

By combining the electronics for a birdhouse camera with precise biological sensors and data archiving, the ability to gather large amounts of objective and scientifically valid data can be piggy-backed on the desire of birdwatchers and other homeowners to watch the development of baby birds in their backyard. Since a typical user of a birdhouse camera will download and view the pictures on an Internet-connected computer, the archives of biological data from their birdhouse can be loaded along with their pictures and sent to a centralized database. The data-collecting functions of the birdhouse can be fully automated in order to make this citizen-collected data perfectly valid for scientific analysis and interpretation.

Prior art includes a number of commercial efforts to place cameras on birdhouses sold to the public (Hawk Eye 2010), but none have the ability to acquire and centralize the collection of valid biological data. Field biologists have long used a wide variety of sensors and data-collectors at bird nests and animal dens, but none have tried disseminating these instruments to general homeowners for use with their otherwise non-scientific backyard birdhouses. U.S. Pat. No. 5,348.922, to Hall, describes use of a photo-electric sensor across the entrance to a birdhouse, but it is a dependent claim on the primary technology for using thermometers to detect when a bird is inside of a birdhouse. No attempt was made by that invention to systematically gather and archive biological data as part of a centralized scientific effort.

### SUMMARY OF THE INVENTION

The present invention is directed to a microprocessor-controlled data-logger with sensors that detect biological activity in or on a birdhouse along with a camera and the ability for untrained users to contribute their data to a collective scientific effort to study wildlife biology or environmental phenomenon. Accompanying software facilitates downloading of pictures and data to an Internet-connected computer where the data can be uploaded and added to centralized databases for scientific analysis.

A circuit is provided with a central processor that controls the timing and storage of the sensor data acquisition as well as triggering pictures in response to user commands, or to a pre-programmed timer or sensor-detected activity.

In addition, at least one of the sensors is a daylight detector or solar panel capable of accurately recording the time of sunsets and sunrises which can act as an objective date-time baseline for the collected data, as well as providing the potential to calculate the geographic location of the birdhouse as confirmation of where the user claimed it was installed. This feature is intended to add scientific validity of the collected data.

Thus it is the object of the present invention to provide an apparatus and method that allows users who have no formal scientific training to collect scientifically valid data that can be added to a growing body of biological and environmental knowledge.

### BRIEF DESCRIPTION OF THE DRAWINGS

The foregoing aspects and advantages of this invention will be more easily understood and appreciated by reference to the following detailed description and accompanying drawings wherein:

FIG. 1 is a cross-sectional view of one exemplary embodiment of the invention constructed in accordance with the invention depicting components of the apparatus installed in a birdhouse.

### DETAILED DESCRIPTION PREFERRED EMBODIMENTS

A method for encouraging citizens to collect scientifically valid biological data according to one embodiment is comprised of a camera-equipped birdhouse with sensors, a data-logger and the ability to download images and data to a computer. The embodiments are unlike prior art for birdhouses in that the features are integrated and used in a way that encourages untrained users to collect and contribute valid scientific data to centralized databases for scientific study.

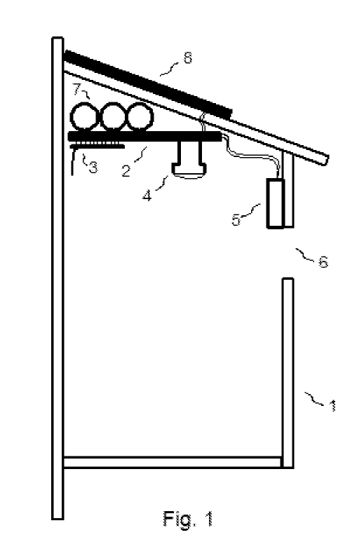

FIG. 1 depicts a vertical cross-section through a birdhouse 1 revealing how components of a preferred embodiment can be fitted and installed inside of the birdhouse. An electronic circuit board 2 is comprised of a central processing unit, memory, clock and embedded software that controls the other elements of the invention. Other elements of the invention include a method of communication with a computer which in FIG. 1 is depicted as a two-way wireless transceiver 3. An image sensor and lens 4 provides for still pictures or video to be taken of activity inside of the birdhouse. One of numerous types of electronic sensors that can be used to acquire biological information is a motion detector 5 installed across the entrance hole 6 of the birdhouse. Power for the electronic circuit board is provided by rechargeable batteries 7 which can recharged by a solar panel 8 mounted on the exterior of the birdhouse. The solar panel 8 or other daylight-detecting sensor can be utilized by the central processor and embedded software for determining the time of day and geographical location that the biological data were collected.

### REFERENCES

U.S. Pat. No. 5,483,922 January 1996. Hall, Lance S. Hawk Eye 2010. Hawk Eye Nature Cam website http://www.birdhousespycam.com Cornell 2010. Cornell Laboratory of Ornithology Nestwatch Program.www.usnpn.org USANPN 2010. National Phenology Network. http://www.rawusanpn.org

The embodiments of the invention in which an exclusive property or privilege is claimed are defined as follows:

1. A method and apparatus for encouraging collection of scientifically valid biological information by untrained citizens for contribution to a centralized database utilizing an apparatus comprising a birdhouse; an electronic circuit board with embedded software for controlling the scientifically-valid collection of biological and environmental data, an image sensor, motion detector, light detection for validating collection time, and the capability for communication with an Internet connected device.

2. A method as in claim 1 utilizing an apparatus wherein: said electronic circuit board further including solar panel or other light-detecting sensor for determining the time or verifying the location of the collected data.

3. A method as in claim 1 utilizing an apparatus wherein: said electronic circuit board further including a microphone or sound transducer for acquiring or analyzing sounds at the birdhouse.

4. A method as in claim 1 utilizing an apparatus wherein: said electronic circuit board further including one or more barometric pressure or humidity sensors for acquiring or analyzing environmental conditions.

5. A method as in claim 1 utilizing an apparatus wherein: said electronic circuit board further including gram scales for acquiring or analyzing the weight of animals or material inside or landing on the birdhouse.

6. A method as in claim 1 utilizing an apparatus wherein: said electronic circuit board further including a vibration sensor for acquiring or analyzing activity in or on the birdhouse.

7. A method as in claim 1 utilizing an apparatus wherein: said electronic circuit board communicates with a computer via a Universal Serial Bus (USB) cable or USB port for connecting a data storage device.

8. A method as in claim 1 utilizing an apparatus wherein: said electronic circuit board communicates with a computer via an Ethernet or other wired connection.

9. A method as in claim 1 utilizing an apparatus wherein: said image sensor and other sensors are directed at the exterior of the entrance to the birdhouse.

10. A method as in claim 1 utilizing an apparatus wherein: said computer is a portable device that can provide a communication conduit to a centralized database of scientific data.

11. A method as in claim 1 utilizing an apparatus wherein: said communication is implemented as a Bluetooth connection to a portable device forming a conduit to a centralized database.

12. A method as in claim 1 utilizing the apparatus installed in a natural cavity nest in a tree or animal den.

13. A method as in claim 1 utilizing the apparatus directed at an open natural bird nest.
